(19) United States
(12) Patent Application Publication
(10) Pub. No.: US 2015/0114954 A1
(43) Pub. Date: Apr. 30, 2015

(54) PORTABLE INDUCTION HEATER

(71) Applicant: Sarge Holdings Co., LLC, Elgin, IL (US)

(72) Inventors: Lawrence S. Erst, Addison, IL (US); Paul G. Astrowski, Carol Stream, IL (US)

(73) Assignee: Sarge Holdings Co., LLC, Elgin, IL (US)

(21) Appl. No.: 14/065,844

(22) Filed: Oct. 29, 2013

(51) Int. Cl. H05B 6/04

(52) U.S. Cl. CPC H05B 6/04
USPC 219/660

(57) ABSTRACT

A portable, handheld induction heater capable of attachment to differently-sized work coils, including a self-resonating oscillator that automatically tunes to the work coil to maintain resonance, a tank circuit for circulating current through the work coil in order to induce a magnetic field in the material to be heated by the induction heater, and a near-zero detector circuit functioning to keep the oscillator operating at a frequency of resonance for the tank circuit.

### BACKGROUND OF THE INVENTION

The present invention relates to portable, handheld induction heaters, particularly those used in the automotive aftermarket, for selectively heating automotive metallic and adjacent components, and removing components bonded or attached to metallic surfaces (e.g., fasteners), or for removing structure attached by means of adhesive (e.g., glass).

Portable, handheld induction heaters are known. See for example, U.S. Pat. Nos. 6,563,096 and 6,670,590, titled “Eddy Current/Hysteretic Heater Apparatus And Method Of Use” and “Eddy Current/Hysteretic Heater Apparatus,” respectively, each of which is incorporated by reference in its entirety into this application. Currently available handheld induction heaters run on power supplied at 110-240 VAC. It would be desirable to run induction heaters on power supplied at other voltages, such as 12 volts, or 10.5-14.5 volts, or up to 24 volts, while using DC power and solid-state electronics, and while also maintaining the size and weight characteristics of currently available portable, handheld induction heaters such as the MINI-DUCTOR® available from Induction Innovations, Inc. of Elgin, Ill. For example, the size envelope may be about 15-inches long, and about 1-2.5 inches in variable width. It would also be advantageous to provide such induction heaters with a mechanism for automatically shutting them off in certain circumstances which might render them dangerous to a user (e.g., over-current and over-voltage situations, hooking up to improper voltage source, over-heating, etc.). It is also desirable to provide such induction heaters which can handle relatively high currents over a specified range of frequencies, and which heat efficiently while staying in resonance during the heating cycle.

Problems with existing induction heaters used in the automotive field include those mentioned above, as well as handling situations involving: undervoltage lockout; overvoltage clamp; load current limitations; self-limiting of fast thermal transients; protection against loss of ground and loss of Vcc; overtemperature shutdown with auto restart (thermal shutdown); inrush current active management by power limitation; and reverse battery protection. As attempts were made to solve these problems, other problems were encountered, including: high current on the PCB; the heat associated with power MOSFET operation; the current handling capabilities of capacitors used in the tank circuit; open and short circuit conditions of the work coil; and battery deep discharge prevention.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Automotive applications” means applications for selectively heating automotive metallic and adjacent components, and removing components bonded or attached to metallic surfaces (e.g., fasteners), or for removing structure attached by means of adhesive (e.g., glass).

### SUMMARY OF THE INVENTION

The objects mentioned above, as well as other objects, are solved by the present invention, which overcomes disadvantages of prior portable induction heaters used in the automotive field, while providing new advantages not previously obtainable with such heaters.

One preferred embodiment includes a portable, handheld induction heater used in automotive applications and capable of attachment to differently-sized work coils. Preferably, the induction heater uses DC power, a solid-state high-side switch, and runs on voltages between 10.5 and 14.5 volts, such as 12 volts. The induction heater preferably includes a self-resonating oscillator, which may include two inverting amplifiers tied together, that automatically tunes to the work coil to maintain resonance; a tank circuit for circulating current through the work coil, in order to induce a magnetic field in the material to be heated by the induction heater, and a near-zero detector circuit for maintaining operation of the oscillator at a frequency of resonance for the tank circuit.

Preferably, the tank circuit includes one or more power MOSFETs, although highly efficient bipolar transistors might be used instead. For example, the tank circuit may include first and second power MOSFETs, with only one of power MOSFETs being powered up at a time. For heat efficiency, the one or more power MOSFETs preferably operate within a resistance range of about 0.001-0.003 ohms.

In one particularly preferred embodiment, the tank circuit is designed to handle current in the range of about 10-90 amps, and operates in a frequency range of between about 25-75 kHz. In this embodiment, the tank circuit may include a plurality of capacitors in parallel with each other, providing a current load of at least about 96 amps.

The induction heater is preferably portable. As one non-limiting example, the induction heater may be designed to fit within the following size envelope: about 15-inches long, and about 1-2.5 inches in variable width.

The induction heater is also preferably capable of handling continuous current in a range of about 40-60 amps, and of handling surge currents up to about 140 amps.

The induction heater may use one or more cooling fans, such as those capable of providing up to about 8.8 CFM, or between about 8.8-15.9 CFM.

Preferably, the induction heater utilizes a printed circuit board including at least 3-ounce double-sided copper paths having an array of plated through via.

The induction heater may also have an attachable battery pack for portably powering the induction heater.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic block diagram of one preferred overall electrical layout which may be used for a preferred portable, handheld induction heater according to the present invention;

FIG. 2 is an electrical diagram for use with a preferred portable, handheld induction heater of the present invention; and

FIG. 3 is a schematic diagram graphically showing, in a preferred embodiment, the voltage across the inductor as a sine wave of alternate polarities, and the resulting current through the inductor as an out-of-phase sine wave.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

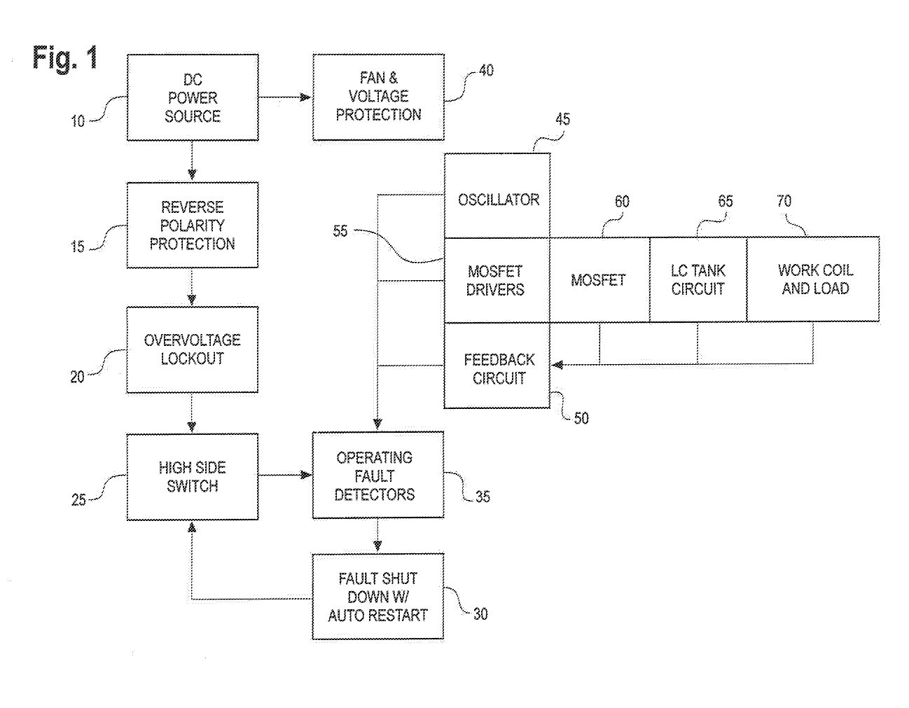

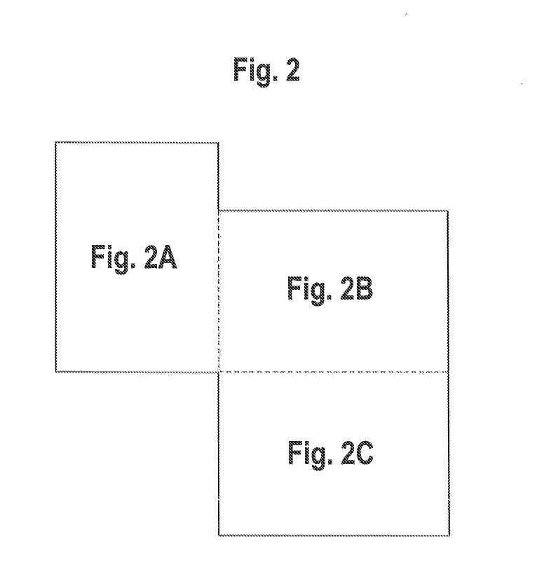

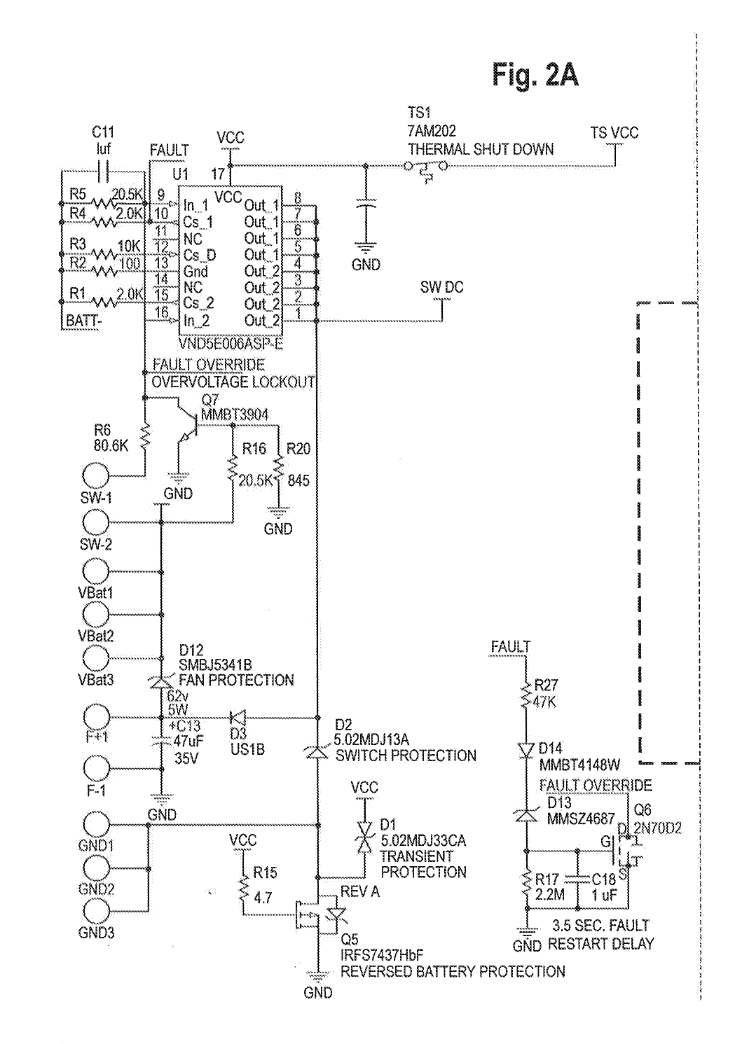

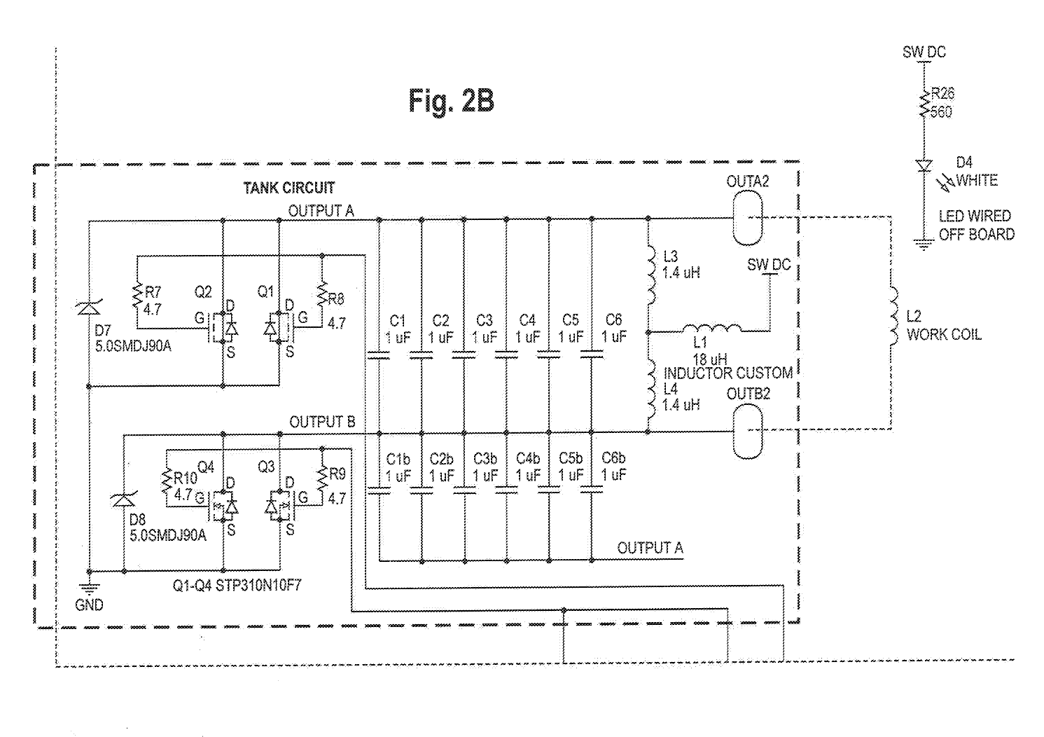

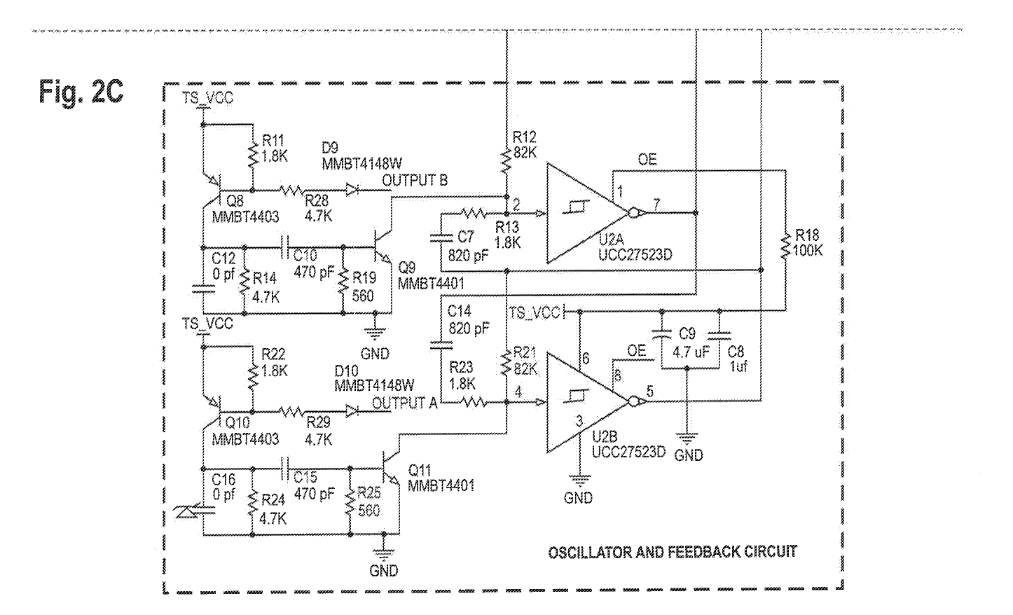

Referring first to FIG. 1, a schematic block diagram of the general layout of the electrical circuit for a preferred embodiment of the portable induction heater of the present invention is shown. Comparison to a more detailed electrical diagram, FIG. 2, may be helpful. At 10 in FIG. 1, a DC power source (e.g., batteries such as VBat1-3 shown on the left side of FIG. 2), may be provided. At 15 in FIG. 1, reverse polarity protection may be provided (see, e.g., Q5 at the lower left of FIG. 2). At 20 in FIG. 1, overvoltage lockout may be provided (see, e.g., the black dot above R6 on the left side of FIG. 2). At 25, a high-side switch may be provided (e.g., VND5EC6 just above Q7 on the left side of FIG. 2). At 35, operating fault detectors (e.g., switch protection, overvoltage lockout, etc., shown in various locations on FIG. 2), may be provided, as well as at 35, fault shut down with auto restart (e.g., “3.5 sec fault restart delay” on FIG. 2). At 40, fan and voltage protection may be provided, as shown in various locations at FIG. 2. Oscillator 45 and feedback circuit 50 of FIG. 1 may be provided as shown by the “oscillator and feedback circuit” (“OF circuit”) in the lower rectangular box of FIG. 2. MOSFET drivers 50 of FIG. 1 are exemplified by U2A and U2B within the OF circuit of FIG. 2. MOSFET 60 of FIG. 1 is exemplified by MOSFETS Q1-Q4 within the “tank circuit” of FIG. 2. An exemplary LC tank circuit 65 is shown in FIG. 2 by the upper rectangular box labeled “tank circuit.” Finally, box 70 of FIG. 1 is exemplified in FIG. 2 by the work coil (L2 on the far right side of FIG. 2) and a load (not shown, such as a fastener to be loosened).

Referring more specifically now to FIG. 2, a preferred OF circuit is shown, and includes a pair of inverting amplifiers U2A, U2B with feedback. U2A and U2B preferably oscillate at the highest frequency they are capable of, but for the cross-coupled feedback through the resistors (R13, R23) and capacitors (C7, C14) on each amplifier. The RC network preferably provides a delay that sets the oscillator frequency and ensures that the output of amplifiers U2A, U2B will always be complimentary.

Still referring to FIG. 2, a preferred tank circuit (within the rectangle labeled accordingly) will now be discussed. The outputs of amplifiers U2A, U2B preferably turn the gates of power MOSFET pairs Q1, Q2 and Q3, Q4 on, alternately. This configuration is preferred as it guarantees a start-up frequency that will only drive one MOSFET on at a time. (Powering up both MOSFETs at the same time can draw an excessive amount of current that may damage the MOSFET.) The LC network formed by C1-C6, C1b-C6b and L2 circulates current through work coil L2. L2 is used to induce a magnetic field in the material to be heated. The LC network at resonance preferably recirculates the energy, producing an alternating magnetic field within work coil L2. Preferably, in addition to converting DC to AC current, the tank circuit functions to increase voltage/power while handling relatively high current in the range of about 10-90 amps. One preferred way this is done is by paralleling together capacitors, such as 12 capacitors, each rated at 1 microfarad, for example, and each of which is capable of handling a substantial amperage (e.g., 8 or 9 amps), providing about or greater than 100 amps of current load.

Still referring to the tank circuit portion of FIG. 2, L1 preferably functions to feed current to center-tapped inductor L3, L4. The chosen value of L1 preferably limits the peak current that the MOSFETs can draw from power source SW DC. When Q1, Q2 is on, current flows through L3, charging this side of the center-tapped inductor. Alternately, L4 may be charged by Q3, Q4. When the MOSFET turns off, the energy stored in that half of the L3, L4 inductor is preferably released into the portion of the tank circuit formed by C1-C6, C1b-C6b and L2. This action boosts the voltage across the tank circuit and allows a very large current, such as up to 170 amps peak in the preferred embodiment, to develop across C1-C6, C1b-C6b and L2.

Referring back to the rectangular “oscillator and feedback” portion of FIG. 2, the oscillator timing components R13, C7 and R23, C14 set the start-up frequency that must be less than the lowest frequency that the tank circuit needs for resonance. The circuit consisting of D10, Q10, C15 and Q11 detects the near zero voltage point at the drain of MOSFET Q1, Q2 and injects a pulse that forces the input of U2A low, forcing Q1, Q2 on. As the two amplifiers U2A, U2B are slaved or tied together to be complimentary, this turns MOSFET Q3, Q4 off. Similarly, the identical circuit consisting of D9, Q8, C10 and Q9 detects the near-zero voltage point at the drain of Q3, Q4 and injects a pulse that forces the input of U2B low, forcing Q3, Q4 on and completing the cycle.

The near-zero voltage point indicates the transfer of charge has completed, and that it is the appropriate time to change polarities. This feedback forces the oscillator frequency to match the resonant frequency of the tank circuit by shortening each half cycle. The value of L2 will vary by the size of the work coil (its diameter and length), and the load when introduced to the flux field created by the current in the work coil. The load represented by a ferrous or conductive material in the field of the work coil changes its properties as it heats until the curie point of the material is reached. There is an abrupt change in the material at this point, limiting the temperature attainable by induction heating. The resonant frequency must be continuously adjusted each half cycle of the oscillation to react to these changes dynamically.

Preferably, for the induction heater embodiment specifically disclosed here, the tank circuit operates in a frequency range of between about 25-75 kHz. It has been found that by reducing the frequency of the tank circuit to this range, a deeper penetration of the magnetic field (more than just skin effects) is provided by the work coil to the material being heated.

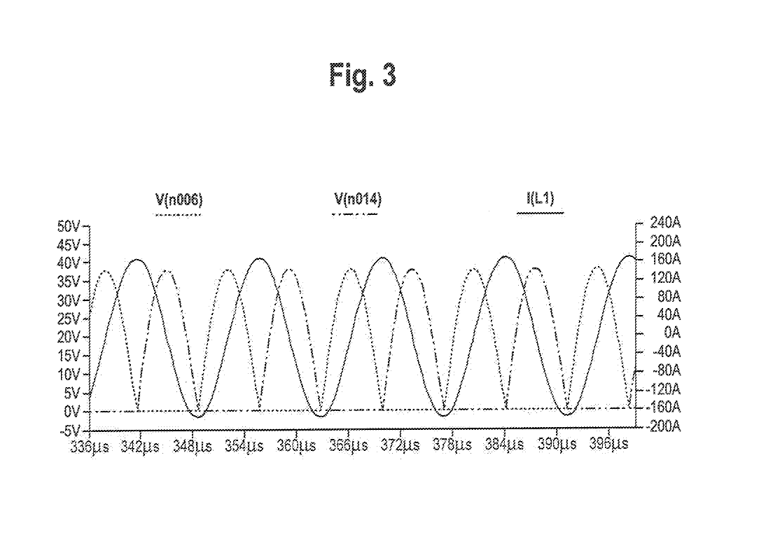

Referring now to FIG. 3, as the energy shifts from C1-C6, C1b-C6b to L2, there is a point where the voltage across one end of the tank circuit approaches zero. In the preferred embodiment, since the current and voltage are out of phase between the capacitor and the inductor, the waveforms at resonance appear as shown across L2. The voltage across the inductor preferably appears as a sine wave of alternate polarities from the alternate switching of the MOSFETs driving each end. It can be seen from FIG. 3 that the resulting current through the inductor appears as an out-of-phase sine wave with the voltage.

Referring again to FIG. 2, as the inductive load varies for different inductive heating applications, it is preferable to provide a mechanism to keep the oscillator operating at the frequency of resonance for the tank circuit. The near-zero detector circuit output can be delayed by the RC timing of R14, C12 and RR24, C16 for each respective half-cycle, in order to achieve the zero voltage point if needed. If the L3, L4 tapped inductor is not balanced, due to manufacturing tolerances, the circuit adjusts the duty cycle of the frequency to compensate.

Using this self-resonating oscillator tuned to an attached work coil, for example, it will be understood that as the load changes the oscillator re-tunes to maintain resonance for maximum power through the work coil. In other words, different work coils can be accommodated, as the circuit will seek resonance and provide maximum power for each.

In the exemplary embodiment shown in FIGS. 1-2, the following may be used: MOSFETs Q1, Q2, Q3, Q4 which operate within certain relatively low resistance ranges, such as 0.001-0.003 ohms, such as STP310N1F7 available from ST Micro Electronics. While the RDSon (resistance value when the MOSFET turns on) may be higher than that specified above, using multiple MOSFETS in parallel will also achieve desirable resistance values in this range, which will keep the MOSFETS cool while operating.

Referring to FIG. 2, a solid-state high-side switch capable of handling continuous current in the range of about 50-60 amps, and surge current in the range of about 100-140 amps, such as VND5E006ASP-E available from ST Micro Electronics, may be used.

In order to handle the high current on the PCB (e.g., greater than 60 amps), 3-ounce double-sided copper paths (6 total ounces of copper) may be used, with an array of plated through via. By using this combination, a cross-sectional area capable of handling the high current is produced on the PCB.

A cooling fan, capable of providing 8.8 CFM, up to 15.9 CFM or more if desired, may also be used to keep the feed inductor, the MOSFETs and the capacitors sufficiently cool. One such cooling fan is AD0412HB-C50, available from ADDA Corp.

An attachable battery pack may be accommodated by the present invention. Battery packs are available in many different nominal voltages, such as 6, 12, 18 and 24 volts The circuit can be easily modified to accommodate these different battery packs with these different voltages.

It will be appreciated that while component values for the exemplary and preferred circuit have been given here, those of ordinary skill in the art will understand that different circuits, and different component values, may be designed and selected while staying within the guidelines and the claims of the present invention. As an example, while a near-zero voltage circuit has been disclosed, it will be understood that a near-zero current circuit could have been used instead, and each type of circuit will be understood to be covered by the claims. As another example, while an induction heater running on 12 volts has been disclosed, it will be understood that a 24-volt induction heater could be designed, particularly if more efficient MOSFETs and/or capacitors are developed in the future. As a further example, instead of employing power MOSFETs in the tank circuit, highly efficient bipolar transistors might be substituted.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. A portable, handheld induction heater for use in automotive applications and capable of attachment to differently-sized work coils, comprising:
a self-resonating oscillator that automatically tunes to the work coil to maintain resonance;
a tank circuit for circulating current through the work coil, in order to induce a magnetic field in the material to be heated by the induction heater; and
a near-zero detector circuit functioning to keep the oscillator for maintaining operation of the oscillator at a frequency of resonance for the tank circuit.

2. The induction heater of claim 1, wherein the tank circuit includes one or more power MOSFETs.

3. The induction heater of claim 2, wherein the tank circuit includes first and second power MOSFETs, and wherein only one of the first and second power MOSFETs is powered up at a time.

4. The induction heater of claim 1, wherein the tank circuit can handle current in the range of about 10-90 amps.

5. The induction heater of claim 4, wherein the tank circuit comprises a plurality of capacitors in parallel with each other, providing a current load of at least about 96 amps.

6. The induction heater of claim 1, wherein the tank circuit operates in a frequency range of between about 25-75 kHz.

7. The induction heater of claim 1, wherein the oscillator comprises two inverting amplifiers tied together.

8. The induction heater of claim 1, wherein the induction heater fits within the following size envelope: about 15-inches long, and about 1-2.5 inches in variable width.

9. The induction heater of claim 1, wherein the induction heater uses DC power and runs on voltages between 10.5 and 14.5 volts.

10. The induction heater of claim 1, wherein the induction heater uses DC power and runs on 12 volts.

11. The induction heater of claim 2, wherein the one or more power MOSFETs operate within a resistance range of about 0.001-0.003 ohms.

12. The induction heater of claim 1, wherein the induction heater uses a solid-state high-side switch.

13. The induction heater of claim 1, wherein the induction heater is capable of handling continuous current in a range of about 40-60 amps.

14. The induction heater of claim 1, wherein the induction heater is capable of handling surge currents up to about 140 amps.

15. The induction heater of claim 1, further comprising a cooling fan.

16. The induction heater of claim 13, wherein the cooling fan is capable of providing up to about 8.8 CFM.

17. The induction heater of claim 13, wherein the cooling fan is capable of providing between about 8.8-15.9 CFM.

18. The induction heater of claim 1, further comprising a printed circuit board including at least 3-ounce double-sided copper paths having an array of plated through via.

19. The induction heater of claim 1, further comprising an attachable battery pack for powering the induction heater.
